(19) United States
(12) Patent Application Publication
(10) Pub. No.: US 2025/0038267 A1
(43) Pub. Date: Jan. 30, 2025

(54) BATTERY

(71) Applicant: ZHUHAI COSMX POWER BATTERY CO., LTD., Zhuhai (CN)

(72) Inventors: Yuju LI, Zhuhai (CN); Hui ZHU, Zhuhai (CN)

(73) Assignee: ZHUHAI COSMX POWER BATTERY CO., LTD., Zhuhai (CN)

(21) Appl. No.: 18/898,565

(22) Filed: Sep. 26, 2024

Related U.S. Application Data
(63) Continuation-in-part of application No. PCT/CN2023/125290, filed on Oct. 18, 2023.

(30) Foreign Application Priority Data
Oct. 18, 2022 (CN) 202211275783.5

(51) Int. Cl. H01M 10/0567; C07F 7/12; H01M 10/0525; H01M 10/0569

(52) U.S. Cl. CPC H01M 10/0567; C07F 7/12; H01M 10/0525; H01M 10/0569; H01M 2300/0028

(57) ABSTRACT

Disclosed are a battery including a positive electrode plate, a negative electrode plate, a separator, and an electrolyte solution. The electrolyte solution includes a lithium salt, an organic solvent, and an additive, and the organic solvent includes at least one carbonate solvent; and the battery satisfies following condition: 1.5≤A/B≤12, where A denotes an overhang of the separator, in a unit of mm; B denotes a mass percentage of the carbonate solvent in the organic solvent. According to the present disclosure, an overhang of a separator and a content of a carbonate solvent in an electrolyte solution are optimized, thereby reducing a shrinkage of the separator in a high-temperature environment.

### CROSS-REFERENCE TO RELATED APPLICATIONS

The present disclosure is a continuation-in-part of International Application No. PCT/CN2023/125290, filed on Oct. 18, 2023, which claims priority to Chinese Patent Application No. 202211275783.5, filed on Oct. 18, 2022. Both of the aforementioned applications are hereby incorporated by reference in their entireties.

### TECHNICAL FIELD

The present disclosure relates to the field of lithium battery technologies, and specifically relates to a battery.

### BACKGROUND

As people pay attention to depletion of non-renewable energy sources and environmental pollution, renewable and clean energy sources are developing rapidly. Lithium-ion batteries have features such as high energy density, long cycle life, low self-discharge rate, and environmental friendliness, and currently have been widely used in consumer electronic products, new energy-powered vehicles, and other power battery products.

However, compared with gasoline vehicles, new energy electric vehicles have problems such as long charging time and safety hazards, which limit a range and a quantity of users. Therefore, a demand for fast charging is becoming more and more urgent.

### SUMMARY

It is found through research that improving a conductivity of an electrolyte solution is conducive to improving fast charging capability of a battery, and the most commonly used method for improving a conductivity of an electrolyte solution is to use a carbonate solvent. However, carbonate solvents generally have a relatively low boiling point and poor performance at a high temperature, and usage of carbonate solvents will affect a shrinkage rate of a separator while improving a conductivity of an electrolyte solution. When a temperature of surface of a battery rises in a short period of time due to a large rate of charging/discharging, overcharging/discharging, a high temperature, or the like, shrinkage of a separator inside the battery may be aggravated, thereby causing contact of a positive electrode plate and a negative electrode plate, and resulting in a short-circuit that will continue to generate heat. In this case, a sharp increase of an internal temperature results in thermal runaway, thus causing a safety accident.

To solve safety problems, such as thermal runaway, caused by shrinkage of a separator for a battery with a fast charging capability, the present disclosure provides a battery. According to the present disclosure, an overhang of a separator and a content of a carbonate solvent in an electrolyte solution are optimized, to ensure that the electrolyte solution has a high electrical conductivity, and an effect of the carbonate solvent on a shrinkage rate of the separator in a high-temperature environment is also reduced.

The present disclosure is intended to be implemented by using the following technical solutions:
a battery, where the battery includes a positive electrode plate, a negative electrode plate, a separator, and an electrolyte solution; the electrolyte solution includes a lithium salt, an organic solvent, and an additive, and the organic solvent includes at least one carbonate solvent; and
the battery satisfies following condition:

$$1.5 \leq A / B \leq 12 ,$$

where A denotes an overhang of the separator, in a unit of mm; and B denotes a mass percentage of the carbonate solvent in the organic solvent.

According to an implementation of the present disclosure, the overhang of the separator refers to a length by which a one-side edge of the separator hangs over a one-side edge of the negative electrode plate in a length direction.

Beneficial effects of the present disclosure are as follows.

The present disclosure provides a battery, in particular a battery with fast charging performance and high safety performance. According to the present disclosure, an overhang of a separator and a content of a carbonate solvent in an electrolyte solution are optimized, thereby reducing a shrinkage of the separator in a high-temperature environment.

### DETAILED DESCRIPTION OF THE EMBODIMENTS

Specific implementations of the present disclosure are described below in detail. It should be understood that the specific implementations described herein are merely used for the purposes of illustrating and explaining the present disclosure, rather than limiting the present disclosure.

The present disclosure provides a battery, where the battery includes a positive electrode plate, a negative electrode plate, a separator, and an electrolyte solution; the electrolyte solution includes a lithium salt, an organic solvent, and an additive, and the organic solvent includes at least one carbonate solvent; and
the battery satisfies following condition:

$$1.5 \leq A / B \leq 12 ,$$

where A denotes an overhang of the separator, in a unit of mm; and B denotes a mass percentage of the carbonate solvent in the organic solvent.

According to an implementation of the present disclosure, the overhang of the separator refers to a length by which a one-side edge of the separator hangs over a one-side edge of the negative electrode plate in a length direction.

According to an implementation of the present disclosure, A/B is 1.5, 2, 2.5, 3, 4, 5, 6, 7, 8, 9, 10, 11, 12, or a point value in a range formed by any two of the foregoing values.

In the foregoing condition (that is, 1.5≤A/B≤12) of the present disclosure, only numerical parts of parameters are used for operation, and unit parts of the parameters are not used for the operation. For example, in Example 1 of the present disclosure, A is 2 mm, B is 0.2, and thus A/B is 10.

According to an implementation of the present disclosure, 2.5≤A/B≤10.

When A/B<1.5, a ratio of the overhang of the separator to a mass percentage of the carbonate solvent in the organic solvent is relatively small (the overhang of the separator is relatively small or the mass percentage of the carbonate solvent in the organic solvent is relatively high), which seriously deteriorates a hot box pass rate of the battery. This is because less overhang of the separator causes seriously shrinkage of the separator when the separator is heated, causing contact of a positive electrode plate and a negative electrode plate and resulting in a short-circuit that will continue to generate heat. In this case, a sharp increase of an internal temperature will result in thermal runaway. In addition, an increase of the mass percentage of the carbonate solvent in the organic solvent improves a shrinkage rate of a separator and also significantly improves kinetics of lithium ion in an electrolyte solution, and a fast charging capability of a lithium ion battery is continuously improved. However, an internal reaction is aggravated, and high-temperature performance deteriorates, and finally a hot box pass rate decreases significantly. When A/B>12, the mass percentage of the carbonate solvent in the organic solvent is relatively small, and a higher conductivity cannot be ensured. Therefore, it is controlled that 1.5≤A/B≤12.

According to an implementation of the present disclosure, 1≤K A≤2, for example, A is 1, 1.1, 1.2, 1.3, 1.4, 1.5, 1.6, 1.7, 1.8, 1.9, or 2. When 1≤A≤2, it avoids that a hot box pass rate is reduced due to serious shrinkage of the separator caused by too small overhang, and also avoids increase of a process difficulty of the separator and loss of battery energy density due to too large overhang of the separator.

According to an implementation of the present disclosure, 0.2≤B≤0.8, for example, B is 0.2, 0.25, 0.3, 0.35, 0.4, 0.45, 0.5, 0.55, 0.6, 0.65, 0.7, 0.75, or 0.8. When 0.2≤B≤0.8, the fast charging capability can be ensured without reducing the hot box pass rate of the battery. In this range, as the mass percentage of the carbonate solvent in the organic solvent is increased, an impact on the hot box pass rate can be reduced by using methods such as increasing the overhang of the separator and adding an additive.

According to an implementation of the present disclosure, a positive electrode active material in the positive electrode plate includes at least one of lithium manganate oxide, lithium iron phosphate, a lithium-nickel-cobalt-manganese ternary material, lithium nickel manganese oxide, or lithium-rich manganese-based material.

According to an implementation of the present disclosure, a negative active material in the negative electrode plate includes at least one of artificial graphite, natural graphite, hard carbon, soft carbon, mesocarbon microbead, a silicon-based negative electrode material, or a lithium-containing metal composite oxide material. For example, the silicon-based negative electrode material includes at least one of elemental silicon, a silicon-carbon material, a silicon-oxygen material, or a silicon alloy.

According to an implementation of the present disclosure, the lithium salt includes at least one of lithium hexafluorophosphate (LiPF₆), lithium difluorophosphate, lithium tetrafluoroborate, lithium hexafluorarsenate(V), lithium perchlorate, lithium bis(fluorosulfonyl)imide, lithium bis(trifluoromethanesulphonyl)imide, lithium bisoxalate borate, or lithium difluorooxalate borate.

According to an implementation of the present disclosure, a percentage of a mass of the lithium salt in a total mass of the electrolyte solution ranges from 12 wt % to 18 wt %, for example, is 12 wt %, 13 wt %, 14 wt %, 15 wt %, 16 wt %, 17 wt %, 18 wt %, or a point value in a range formed by any two of the foregoing values.

According to an implementation of the present disclosure, the carbonate solvent includes at least one of methyl formate, ethyl formate, propyl formate, butyl formate, methyl acetate, ethyl acetate, propyl acetate, butyl acetate, methyl propionate, ethyl propionate (EP), propyl propionate (PP), butyl propionate, methyl butyrate, ethyl butyrate, propyl butyrate, or butyl butyrate.

According to an implementation of the present disclosure, the organic solvent further includes at least one of following compounds: propylene carbonate, ethyl methyl carbonate, ethylene carbonate (EC), dimethyl carbonate (DMC), diethyl carbonate, γ-butyrolactone, or sulfolane.

According to an implementation of the present disclosure, a percentage of a mass of the organic solvent in a total mass of the electrolyte solution ranges from 10 wt % to 80 wt %, for example, is 10 wt %, 20 wt %, 30 wt %, 40 wt %, 50 wt %, 60 wt %, 70 wt %, 80 wt %, or a point value in a range formed by any two of the foregoing values.

According to an implementation of the present disclosure, the additive includes a first additive, and the first additive includes at least one of vinylene carbonate (VC), fluoroethylene carbonate (FEC), vinyl ethylene carbonate (VEC), ethylene sulfate (DTD), 1,3-propane sultone (PS), ethylene sulphite (ES), tris(trimethylsilyl) borate (TMSB), or tris(trimethylsilyl) phosphate (TMSP).

According to an implementation of the present disclosure, the additive further includes a second additive, and the second additive is selected from at least one of the compounds shown in Formula 1:

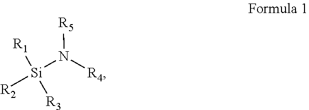

where R₁, R₂, R₃, R₄, and R₅ are the same or different from each other, and are independently selected from hydrogen, halogen, an aldehyde group, a substituted or unsubstituted alkyl group, a substituted or unsubstituted alkenyl group, or a substituted or unsubstituted alkynyl group. If there is a substitution, a substituent is at least one of halogen, an alkyl group or an aldehyde group.

According to an implementation of the present disclosure, R₁, R₂, R₃, R₄, and R₅ are the same or different from each other, and are independently selected from hydrogen, halogen, an aldehyde group, a substituted or unsubstituted C₁₋₆ alkyl group, a substituted or unsubstituted C₂₋₆ alkenyl group, or a substituted or unsubstituted C₂₋₆ alkynyl group. If there is a substitution, a substituent is at least one of halogen, a C₁₋₆ alkyl group, or an aldehyde group.

According to an implementation of the present disclosure, R₁, R₂, R₃, R₄, and R₅ are the same or different from each other, and are independently selected from hydrogen, halogen, an aldehyde group, a substituted or unsubstituted C₁₋₃ alkyl group, a substituted or unsubstituted C₂₋₃ alkenyl group, or a substituted or unsubstituted C₂₋₃ alkynyl group. If there is a substitution, a substituent is at least one of halogen, a C₁₋₃ alkyl group, or an aldehyde group.

According to an implementation of the present disclosure, R₁, R₂, R₃, R₄ and R₅ are the same or different from each other, and are independently selected from hydrogen, fluorine, —C(═O)H, a substituted or unsubstituted C₁₋₃ alkyl group, a substituted or unsubstituted C₂₋₃ alkenyl group, or a substituted or unsubstituted C₂₋₃ alkynyl group. If there is a substitution, a substituent is at least one of fluorine, C₁₋₃ alkyl group, or —C(═O)H.

According to an implementation of the present disclosure, a compound of Formula 1 is selected from at least one of following compound I to compound IV:

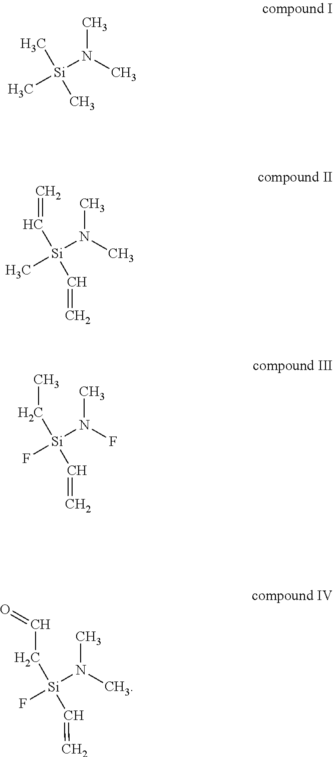

According to an implementation of the present disclosure, a percentage of a mass of the first additive in a total mass of the electrolyte solution ranges from 0.5 wt % to 4 wt %, for example, is 0.5 wt %, 0.6 wt %, 0.7 wt %, 0.8 wt %, 0.9 wt %, 1 wt %, 1.2 wt %, 1.5 wt %, 1.8 wt % 2 wt %, 2.2 wt %, 2.5 wt %, 2.8 wt %, 3 wt %, 3.2 wt %, 3.5 wt %, 3.6 wt %, 3.8 wt %, 4 wt %, or a point value in a range formed by any two of the foregoing values.

According to an implementation of the present disclosure, a percentage of a mass of the second additive in a total mass of the electrolyte solution ranges from 0.5 wt % to 3 wt %, for example, is 0.5 wt %, 0.6 wt %, 0.7 wt %, 0.8 wt %, 0.9 wt %, 1 wt %, 1.2 wt %, 1.5 wt %, 1.8 wt %, 2 wt %, 2.2 wt %, 2.5 wt %, 2.8 wt %, 3 wt %, or a point value in a range formed by any two of the foregoing values.

According to an implementation of the present disclosure, the first additive and the second additive may be obtained through preparation in a method known in the art, or may be obtained through commercial purchase.

According to an implementation of the present disclosure, a charging cut-off voltage of the battery is 4.45 V or above.

According to an implementation of the present disclosure, the battery is a lithium-ion battery.

A compound shown in Formula 1 is added to the electrolyte solution of the battery provided in the present disclosure, so that a dense and stable interface film may be formed at a negative electrode, heat may also be absorbed when an internal temperature of the battery is relatively high, so as to reduce a temperature of a battery system and a risk of thermal runaway, thereby improving fast charging performance and safety performance of the battery.

The following further describes the present disclosure in detail with reference to specific embodiments. It should be understood that the following embodiments are merely for the purposes of illustrating and explaining the present disclosure, and should not be construed as limiting the protection scope of the present disclosure. Any technology implemented based on the foregoing contents of the present disclosure falls within the protection scope of the present disclosure.

The experimental method used in the following examples is a conventional method unless otherwise specified. The reagent, the material, and the like used in the following examples may be obtained from a commercial channel without special description.

In the description of the present disclosure, it should be noted that the terms “first”, “second”, or the like, are only used for descriptive purposes, and do not indicate or imply relative importance.

### Preparation of a Lithium-Ion Battery

### (1) Preparation of a Positive Electrode Plate

A positive electrode active material lithium nickel cobalt manganese oxide (NCM622), a binder polyvinylidene fluoride (PVDF), and a conductive agent acetylene black were mixed at a weight ratio of 96.5:2:1.5, added with N-methylpyrrolidone (NMP). The mixture was stirred under action of a vacuum mixer until a mixed system became a positive electrode slurry with uniform fluidity. The positive electrode slurry was evenly applied on aluminum foil having a thickness of 7 m. The coated aluminum foil was baked in a five-stage oven with different temperatures and then dried in an oven at 120° C. for 8 hours, followed by rolling and cutting, to obtain the positive electrode plate.

### (2) Preparation of a Negative Electrode Plate

A negative electrode active material artificial graphite, a thickener sodium carboxymethyl cellulose (CMC-Na), a binder styrene-butadiene rubber, a conductive agent acetylene black, and a conductive agent single-walled carbon nanotube (SWCNT) were mixed at a weight ratio of 95.9:1:2:1:0.1, added into deionized water. The mixture was stirred under action of a vacuum mixer to obtain a negative electrode slurry. The negative electrode slurry was evenly applied on copper foil having a thickness of 6 m, and then drying (temperature: 85° C., time: 5 hours), rolling and die cutting were carried out to obtain the negative electrode plate.

### (3) Preparation of an Electrolyte Solution

In an argon-filled glove box (moisture<10 ppm, oxygen<1 ppm), EC, DMC, EP, and PP were evenly mixed, where a sum of masses of EP and PP (a mass ratio of EP to PP was 2:1) is a percentage B of a mass of a carbonate solvent in an electrolyte solution in a mass of an organic solvent in the electrolyte solution. Then 14 wt % LiPF6 and a specific content of an additive were rapidly added to the mixed solution, and the mixture was stirred evenly to obtain the electrolyte solution.

### (4) Preparation of a Separator

A polyethylene separator with a thickness of 9 m is selected, and a one-side edge of the separator hangs over a one-side edge of the negative electrode plate by a specific length, namely, an overhang of the separator.

### (5) Preparation of a Lithium-Ion Battery

The foregoing prepared positive electrode plate, separator, and negative electrode plate were wound to obtain an unfilled bare cell. The bare cell was placed in an outer packaging foil, the prepared electrolyte solution was injected into the dried bare cell, and after processes such as vacuum packaging, standing, forming, shaping, and sorting, the lithium-ion battery required was obtained.

Methods for testing performance of lithium-ion batteries prepared in Examples and Comparative Examples are as follows.
(1) Test for conductivity: A conductivity of an electrolyte solution prepared at 25° C. was tested by using a conductivity meter and a platinum black electrode DSJ-1C.
(2) Hot box test: A prepared lithium-ion battery was charged to an upper limit voltage 4.45 V, and then placed in a 135° C. thermostat for 120 minutes, to observe whether the battery catches fire or explodes. If the lithium-ion battery did not caught fire and exploded, it was considered as passed.
(3) Temperature rise test during charging: A prepared lithium-ion battery was placed in a 25° C. thermostat, and charged at a rate of 5 C, to detect a degree of temperature rise of a surface of the battery when the battery is charged at 5 C relative to being not charged, that is, the degree of temperature rise of the battery is equal to a temperature of the surface of the battery charged at 5 C minus a temperature of the surface of the battery that is not charged.

### Comparative Examples 1 and 2 and Examples 1-6

The additives in Comparative examples 1 and 2 and Examples 1-6 are vinylene carbonate accounting for 1 wt of a total mass of an electrolyte solution, fluoroethylene carbonate accounting for 1 wt %0 of a total mass of an electrolyte solution, ethylene sulfate accounting for 2 wt % of a total mass of an electrolyte solution, and 1,3-propane sultone accounting for 2 wt %0 of a total mass of an electrolyte solution.

TABLE 1
Performance test results and composition of batteries
in Comparative examples 1 and 2 and Examples 1-6

| | | | | | | Battery |
|---|---|---|---|---|---|---|
| | | A | | Hot box | Conductivity | temperature |
| | A/B | (mm) | B | pass rate | ms/cm | rise (° C.) |
| Comparative | 1.25 | 0.5 | 0.4 | 0/10 pass | 8.7 | 63 |
| Example 1 | | | | | | |
| Comparative | 20 | 2 | 0.1 | 10/10 pass | 6.1 | 53 |
| Example 2 | | | | | | |
| Example 1 | 10 | 2 | 0.2 | 10/10 pass | 7.2 | 59 |
| Example 2 | 5 | 2 | 0.4 | 10/10 pass | 8.5 | 62 |
| Example 3 | 3.3 | 2 | 0.6 | 6/10 pass | 8.8 | 75 |
| Example 4 | 2.5 | 2 | 0.8 | 3/10 pass | 9.4 | 80 |
| Example 5 | 3.75 | 1.5 | 0.4 | 10/10 pass | 8.2 | 63 |
| Example 6 | 2.5 | 1 | 0.4 | 10/10 pass | 8.4 | 62 |

It may be learned from Comparative Example 2 and Examples 1-4 that, with an increase in a content of the low-boiling carbonate solvent, the hot box pass rate of the batteries significantly decreases. This is because that the increase in a content of a low-boiling carbonate solvent improves a shrinkage rate of a separator and also significantly improves kinetics of lithium ion in an electrolyte solution, and a fast charging capability of a lithium ion battery is continuously improved. However, an internal reaction is aggravated, and high-temperature performance deteriorates, and finally a hot box pass rate decreases significantly. For example, in Example 4, the hot box pass rate is only 3000.

It may be learned from Comparative Example 1, Example 2, and Examples 5 and 6 that, with a decrease in a ratio of the overhang of the separator to a content of the carbonate solvent decreases (the overhang of the separator decreases), the heat box pass rate decreases. This is because that at a high temperature, usage of the carbonate solvent significantly improves a shrinkage rate of the separator, thus deteriorating heat box performance. Therefore, it is ensured that 1.5≤A/B≤12.

### Examples 7-18

The additives in Examples 7-18 are vinylene carbonate accounting for 1 wt % of a total mass of an electrolyte solution, fluoroethylene carbonate accounting for 1 wt % of a total mass of an electrolyte solution, ethylene sulfate accounting for 2 wt % of a total mass of an electrolyte solution, 1,3-propane sultone accounting for 2 wt of a total mass of an electrolyte solution, and a compound showing in Formula 1.

TABLE 2
Performance test results and composition of batteries in Examples 7-18

| | | | | Type and content | | Battery |
|---|---|---|---|---|---|---|
| | | A | | of a second | Hot box | temperature |
| | A/B | (mm) | B | additive (wt %) | pass rate | rise (° C.) |
| Example 7 | 3.3 | 2 | 0.6 | Compound I: 0.3 | 6/10 pass | 64 |
| Example 8 | 3.3 | 2 | 0.6 | Compound I: 3.5 | 8/10 pass | 76 |
| Example 9 | 3.3 | 2 | 0.6 | Compound I: 0.5 | 8/10 pass | 55 |
| Example 10 | 3.3 | 2 | 0.6 | Compound I: 1 | 9/10 pass | 42 |
| Example 11 | 3.3 | 2 | 0.6 | Compound I: 2 | 9/10 pass | 36 |
| Example 12 | 3.3 | 2 | 0.6 | Compound I: 3 | 7/10 pass | 60 |
| Example 13 | 3.3 | 2 | 0.6 | Compound II: 1 | 9/10 pass | 41 |
| Example 14 | 3.3 | 2 | 0.6 | Compound III: 1 | 9/10 pass | 43 |
| Example 15 | 3.3 | 2 | 0.6 | Compound IV: 1 | 9/10 pass | 44 |
| Example 16 | 3.3 | 2 | 0.6 | Compound I: 0.5 + | 9/10 pass | 41 |
| | | | | Compound II: 0.5 | | |
| Example 17 | 3.3 | 2 | 0.6 | Compound I: 0.5 + | 10/10 pass | 39 |
| | | | | Compound III: 0.5 | | |
| Example 18 | 3.3 | 2 | 0.6 | Compound III: 0.5 + | 10/10 pass | 37 |
| | | | | Compound IV: 0.5 | | |

It may be learned from Example 3 and Example 7 that, when the content of the compound shown in Formula 1 is less than 0.5 wt %, heat absorbed is limited, the temperature rise of surface of the battery is relatively high, the internal temperature of the battery cannot be effectively reduced, and a hot box pass rate is not significantly improved. It may be learned from Example 3 and Example 8 that, when the content of the compound shown in Formula 1 is greater than 3 wt 00, although a reaction can occur to absorb heat, internal impedance may also be increased, which results in a large increase in a temperature rise of the battery surface, and an internal temperature of the battery cannot be significantly reduced. It may be learned from Examples 9 to 18 that, when the content of the compound shown in Formula 1 ranges from 0.5 wt % to 3 wt %, a reaction can occur, internal heat is absorbed, a hot box pass rate is significantly improved, and temperature rise of the battery is relatively low, which indicates that the battery has better fast charging performance.

The implementations of the present disclosure are described above. However, the present disclosure is not limited to the foregoing implementations. Any modifications, equivalent replacements, improvements, and the like within the spirit and principle of the present disclosure shall fall within the scope of protection of the present disclosure.

What is claimed is:

1. A battery, comprising a positive electrode plate, a negative electrode plate, a separator, and an electrolyte solution; wherein the electrolyte solution comprises a lithium salt, an organic solvent, and an additive, the organic solvent comprises at least one carbonate solvent; and
the battery satisfies following condition:
$$1.5 \leq A / B \leq 12 ,$$
wherein A denotes an overhang of the separator, in a unit of mm; B denotes a mass percentage of the carbonate solvent in the organic solvent; and the overhang of the separator means a length by which a one-side edge of the separator hangs over a one-side edge of the negative electrode plate.

2. The battery according to claim 1, wherein 2.5≤A/B≤10.

3. The battery according to claim 1, wherein 1≤A≤2.

4. The battery according to claim 1, wherein 0.2≤B≤0.8.

5. The battery according to claim 1, wherein the carbonate solvent comprises at least one of methyl formate, ethyl formate, propyl formate, butyl formate, methyl acetate, ethyl acetate, propyl acetate, butyl acetate, methyl propionate, ethyl propionate, propyl propionate, butyl propionate, methyl butyrate, ethyl butyrate, propyl butyrate, or butyl butyrate.

6. The battery according to claim 5, wherein the carbonate solvent comprises ethyl propionate and propyl propionate.

7. The battery according to claim 1, wherein the additive comprises a first additive, and the first additive comprises at least one of vinylene carbonate, fluoroethylene carbonate, vinyl ethylene carbonate, ethylene sulfate, 1,3-propane sultone, ethylene sulphite, tris(trimethylsilyl) borate, or tris(trimethylsilyl) phosphate.

8. The battery according to claim 1, wherein the additive comprises a second additive, and the second additive is selected from at least one of compounds in Formula 1: 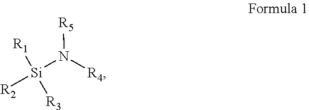
wherein R₁, R₂, R₃, R₄, and R₅ are independently selected from hydrogen, halogen, an aldehyde group, a substituted or unsubstituted alkyl group, a substituted or unsubstituted alkenyl group, or a substituted or unsubstituted alkynyl group; and when there is a substitution, a substituent is at least one of halogen, an alkyl group or an aldehyde group.

9. The battery according to claim 8, wherein R₁, R₂, R₃, R₄, and R₅ are independently selected from hydrogen, halogen, an aldehyde group, a substituted or unsubstituted C₁₋₆ alkyl group, a substituted or unsubstituted C₂₋₆ alkenyl group, or a substituted or unsubstituted C₂₋₆ alkynyl group; and when there is a substitution, a substituent is at least one of halogen, a C₁₋₆ alkyl group or an aldehyde group.

10. The battery according to claim 9, wherein R₁, R₂, R₃, R₄ and R₅ are independently selected from hydrogen, fluorine, —C(═O)H, a substituted or unsubstituted C₁₋₃ alkyl group, a substituted or unsubstituted C₂₋₃ alkenyl group, or a substituted or unsubstituted C₂₋₃ alkynyl group; and when there is a substitution, a substituent is at least one of fluorine, C₁₋₃ alkyl group, or —C(═O)H.

11. The battery according to claim 8, wherein a compound of Formula 1 is selected from at least one of following compound I to compound IV:

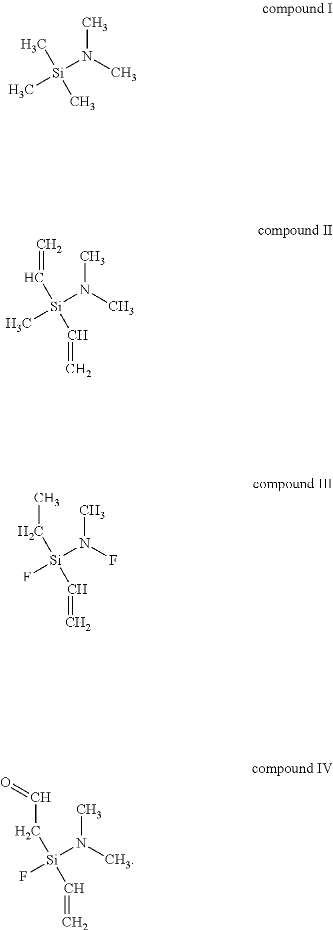

12. The battery according to claim 7, wherein a percentage of a mass of the first additive in a total mass of the electrolyte solution ranges from 0.5 wt % to 4 wt %.

13. The battery according to claim 8, wherein a percentage of a mass of the second additive in a total mass of the electrolyte solution ranges from 0.5 wt % to 3 wt %.

14. The battery according to claim 1, wherein a positive electrode active material in the positive electrode plate comprises at least one of lithium manganate oxide, lithium iron phosphate, a lithium-nickel-cobalt-manganese ternary material, lithium nickel manganese oxide, or lithium-rich manganese-based material.

15. The battery according to claim 1, wherein a negative active material in the negative electrode plate comprises at least one of artificial graphite, natural graphite, hard carbon, soft carbon, mesocarbon microbead, a silicon-based negative electrode material, or a lithium-containing metal composite oxide material.

16. The battery according to claim 1, wherein the lithium salt comprises at least one of lithium hexafluorophosphate, lithium difluorophosphate, lithium tetrafluoroborate, lithium hexafluorarsenate(V), lithium perchlorate, lithium bis(fluorosulfonyl)imide, lithium bis(trifluoromethanesulphonyl)imide, lithium bisoxalate borate, or lithium difluorooxalate borate.

17. The battery according to claim 1, wherein a percentage of a mass of the lithium salt in a total mass of the electrolyte solution ranges from 12 wt % to 18 wt %.

18. The battery according to claim 1, wherein the organic solvent further comprises at least one of following compounds: propylene carbonate, ethyl methyl carbonate, ethylene carbonate, dimethyl carbonate, diethyl carbonate, fluoroethylene carbonate, γ-butyrolactone, or sulfolane.

19. The battery according to claim 1, wherein a percentage of a mass of the organic solvent in a total mass of the electrolyte solution ranges from 10 wt % to 80 wt %.

20. The battery according to claim 1, wherein a charge cut-off voltage of the battery is 4.45 V or higher; and/or
the battery is a lithium-ion battery.
